(19) United States
(12) Patent Application Publication
(10) Pub. No.: US 2025/0354425 A1
(43) Pub. Date: Nov. 20, 2025

(54) Novel Linkage and Door Design for Panel Doors

(71) Applicant: Merrill Stulken, Curtis, WA (US)

(72) Inventor: Merrill Stulken, Curtis, WA (US)

(21) Appl. No.: 18/975,940

(22) Filed: Dec. 10, 2024

Related U.S. Application Data
(60) Provisional application No. 63/648,326, filed on May 16, 2024.

(51) Int. Cl. E05F 7/02; E05D 3/12; E05D 3/18; E05F 15/00; E06B 3/70; E06B 3/72

(52) U.S. Cl. CPC E05F 7/02; E05D 3/12; E05D 3/18; E05F 15/00; E06B 3/72; E06B 2003/7044

(57) ABSTRACT

A panel door with a swing/link arm system attached to a base coupling point with upper and lower connectors coupled to a column attached to the panel door. The former assembly creates a unique geometry that allows for easily raising and lowering a panel door. Further, it includes raising and lowering the panel door using a linear actuator or a hydraulic cylinder. The oversized doors must be stabilized using a truss or a W-stabilizer.

### CROSS REFERENCE TO RELATED APPLICATIONS

This application claims priority to the co-pending Provisional U.S. Application, Ser. No. 63/648,326, filed on May 16, 2024, which is hereby incorporated by reference for all purposes.

### BACKGROUND

The present disclosure relates generally to large panel doors. In particular, garage, agricultural, aircraft, loading dock, and industrial doors. The disclosure describes a novel door and method for opening and closing the door.

Panel doors are found to be used in many applications, but for brevity, the non-limiting example of a garage door will be used. Garage doors comprise several panels that are attached by hinges. The opening and closing of a garage door are accomplished using a torsion spring attached to drums from which cables are connected to the door. At the ends of the panels are rollers that glide through a track. When opening and closing the door, the force of spring causes the door to move via the cable roller system, and the hinges allow the door to bend as the door travels up or down through the track system. Hereinafter, this is collectively referred to as the Torsion Spring Design.

The above method has several disadvantages. First is safety; the torsion spring is under constant tension and can be dangerous when the tension must be released. Second, all the force is transferred to the building frame, requiring reinforcement and increasing construction costs. Lastly, the constant tension on the spring causes frequent failures that require frequent maintenance.

Thus, there exists a need for a means that improves upon Torsion Spring Design for opening and closing panel doors. The disclosure describes an example of a new and useful design that improves on the Torsion Spring Design and is discussed below.

### SUMMARY

A panel door with a swing/link arm system attached to a base coupling point with upper and lower connectors coupled to a column attached to the panel door. The former assembly creates a unique geometry that easily raises and lowers a panel door. Further, it includes raising and lowering the panel door using a linear actuator or a hydraulic cylinder. The oversized doors must be stabilized using a truss or a W-stabilizer.

### BRIEF DESCRIPTION OF THE DRAWINGS

FIG. 1 is a side view of the door.

FIG. 2 is a rear view of the door.

FIG. 3 shows the door partly open, showing the 60/40 balance.

FIG. 4 shows the door with the means to raise and lower the door.

FIG. 5 shows the door with a reinforcing truss.

FIG. 6 shows the door with a W stabilizer.

### DETAILED DESCRIPTION

The disclosed widgets will become better understood by reviewing the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, every contemplated variation is not individually described in the following detailed description.

Throughout the following detailed description, examples of various widgets are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein unless otherwise indicated.

“Substantially” means more-or-less conforming to the particular dimension, range, shape, concept, or other aspect modified by the term, such that a feature or component need not conform strictly. For example, a “substantially cylindrical” object resembles a cylinder but may have one or more deviations from a proper cylinder.

“Comprising,” “including,” and “having” (and conjugations thereof) are used interchangeably to mean including but not necessarily limited to and are open-ended terms not intended to exclude additional elements or method steps not expressly recited.

Terms such as “first,” “second,” and “third” are used to distinguish or identify various members of a group or the like and are not intended to denote a serial, chronological, or numerical limitation.

“Coupled” means connected, either permanently or releasably, directly or indirectly through intervening components.

“Communicatively coupled” means that an electronic device exchanges information with another electronic device, either wirelessly or with a wire-based connector, whether directly or indirectly, through a communication network.

“Controllably coupled” means that an electronic device controls the operation of another electronic device.

### Novel Linkage and Door Design for Panel Doors

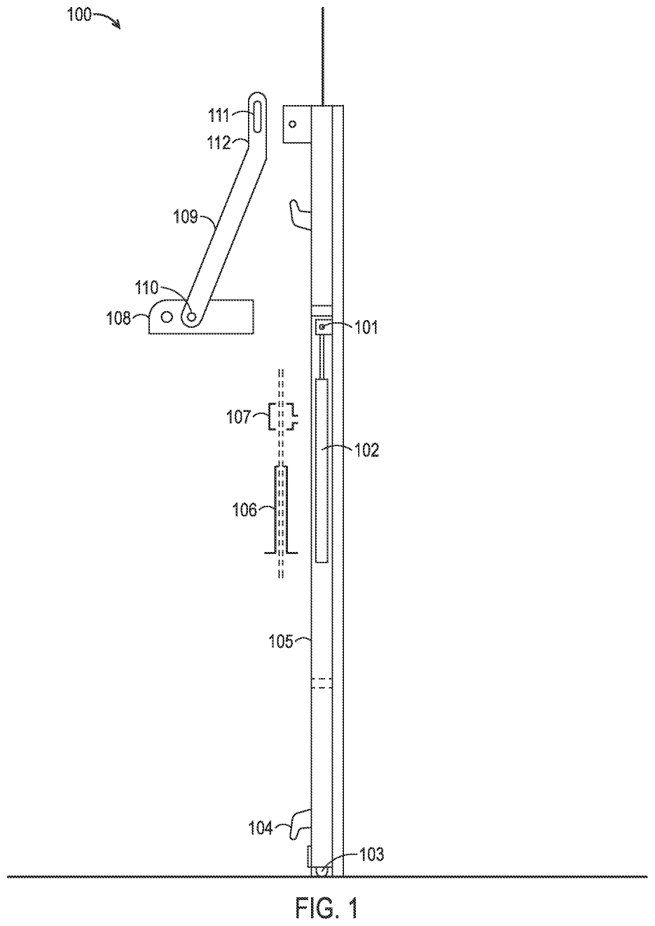

Referring to FIGS. 1 to 3, Novel Linkage and Door Design for Panel Doors will now be described. Unlike the non-limiting example of a garage door, the current door does not fold. Instead, it is a one-piece door. Moreover, the door does not include a torsion spring, drums, rollers, or tracts. Instead, it uses a novel linkage to open and close the door. However, like a garage door, the door can be hydraulically or electrically operated, using a push button panel controlled or optional remote.

The door will be primarily made from metal tubes, with non-limiting examples including steel or aluminum. The operation will use any known method for opening and closing panel doors. Non-limiting examples of these methods include an electric motor driving a hydraulic pump or a linear gear system.

Unlike the Torsion Spring Design, a swing/link arm and pivot will open and close the door. The door's balance will be a 60/40% ratio, with 60% below the pivot point in most cases. A pivot pin will be attached to a hydraulic cylinder rod end or a linear actuator nut gland. The door is raised linearly as the hydraulic cylinder or linear actuator lifts by rotating. The door is attached at the top of the swing/link arm to cause an up-and-inward geometry until it is fully open and in a horizontal position just below the finished header of the building.

The swing/link arm design simplifies door movement. It eliminates the need for the elements of the Torsion Spring Design, e.g., hinges, torsion springs, drums, cables, rollers, and tracks. The simple design eliminates the need for adjustments, maintenance, or lubrication. Additionally, the door geometry allows the design to be nearly balanced in the door opening, significantly reducing the stress on the building door frames and building costs. The lifting by either hydraulic cylinders or linear actuators transfers the vertical loads directly into the foundation of the building instead of the header and building structure, again saving building costs.

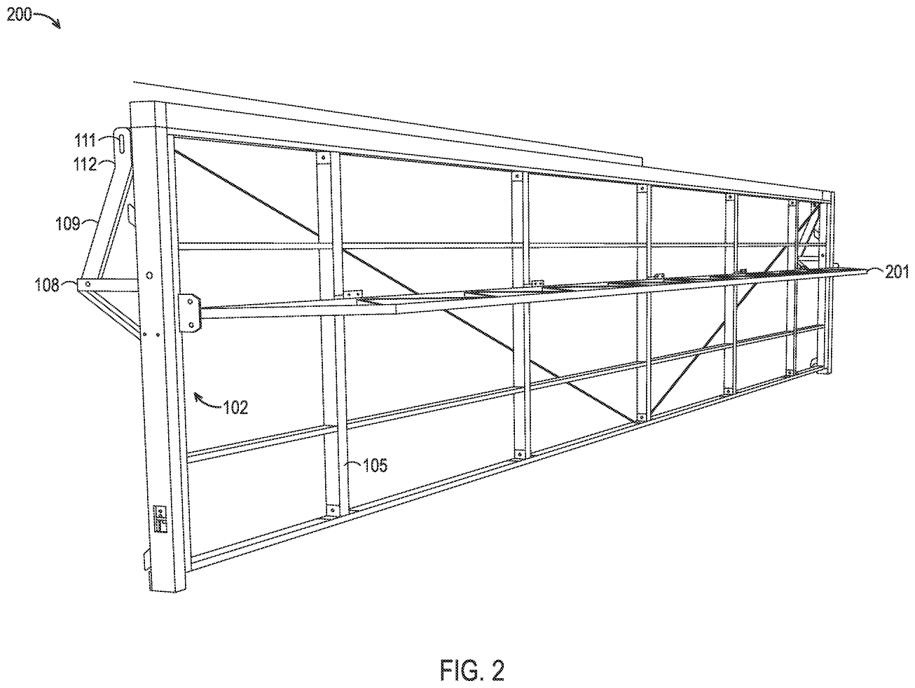

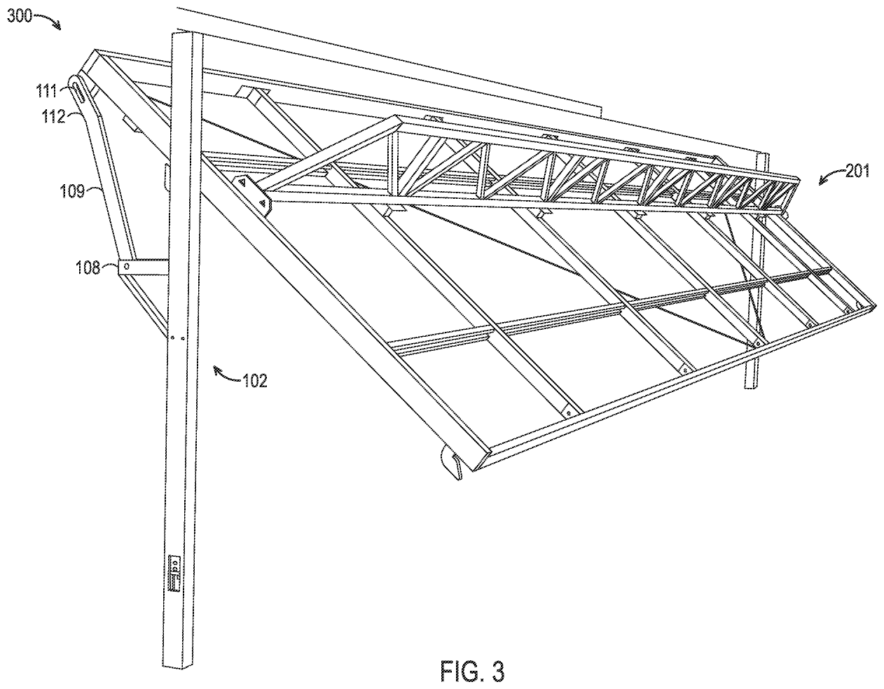

FIG. 1 shows the door in the closed position, swing/link arm, pivot point, hydraulic cylinder, linear actuator, door lock, and bottom door seal. FIG. 2 reviews the closed door and shows the attachment of the swing/link arm assembly to the positions of the hydraulic cylinder or linear actuator. FIG. 2 further includes a stabilizing truss. Stabilizing trusses are required for larger doors. FIG. 3 shows a partially open door demonstrating the movement of the door and the actuation of the swing/link arm system.

FIG. 1 shows a panel door, 100, with the swing/link arm system, 109, attached. Item 101 is the pivot point of the main door frame. It consists of a pivot pin. Reaching the initial vertical lift allows the door to begin with the geometry characteristic of the swing/link arm, 109. The pivot point, 101, consists of either a linear actuator threaded gland nut, 107, or a pivot lift/push block, 503, used on the hydraulic cylinder option. Both accomplish the lifting and pivoting actions for my swing/link arm, 109.

Item 102 shows a non-limiting means to raise and lower the door system. Depending on each door system's application and loading requirement, a linear actuator, 106 is an option, or a hydraulic cylinder, 502, can be used. The hydraulic option requires a hydraulic pump, valves, and plumbing suited for each application. The linear actuator option requires a suitable linear actuator, electrical controls, and associated wiring to lift and operate the door system. In addition to the former, any other mechanism known in the art to raise and lower a panel door may be used, including manual operation.

The door further comprises a bottom rubber threshold seal, 103, the seal, 103, couples to the bottom of the actual door bottom tube member. The door includes a lock, 104. The door system has locks at the lower and upper portions of the door frames.

Non-limiting examples of column 105 include a wide flange made of a steel or aluminum beam or a square or rectangular built-up support column suited for the actual door application. Smaller doors require much less support than larger doors; the support column will be engineered for the required loads. Column 105 supports the door's weight as it operates and is the mounting support for the linear actuator, 106, or the hydraulic cylinder lift option.

The swing/link arm, 109, is coupled to the base coupling point, 108. The base coupling point, 108, is the lower structural mounting point for the swing/link arm, 109, further comprising a lower connector, 404, and an upper connector, 405, where the base coupling point is coupled directly to column 105; the combination creates an essential structural member that achieves a unique geometry for raising and lowering the door. It provides a vertical rise, allowing the door to self-release from any locks and clear any light obstruction, with non-limiting examples, including snow and leaves build-up in front of the door before it begins the gentle inward/outward opening action to a final full horizontal open position.

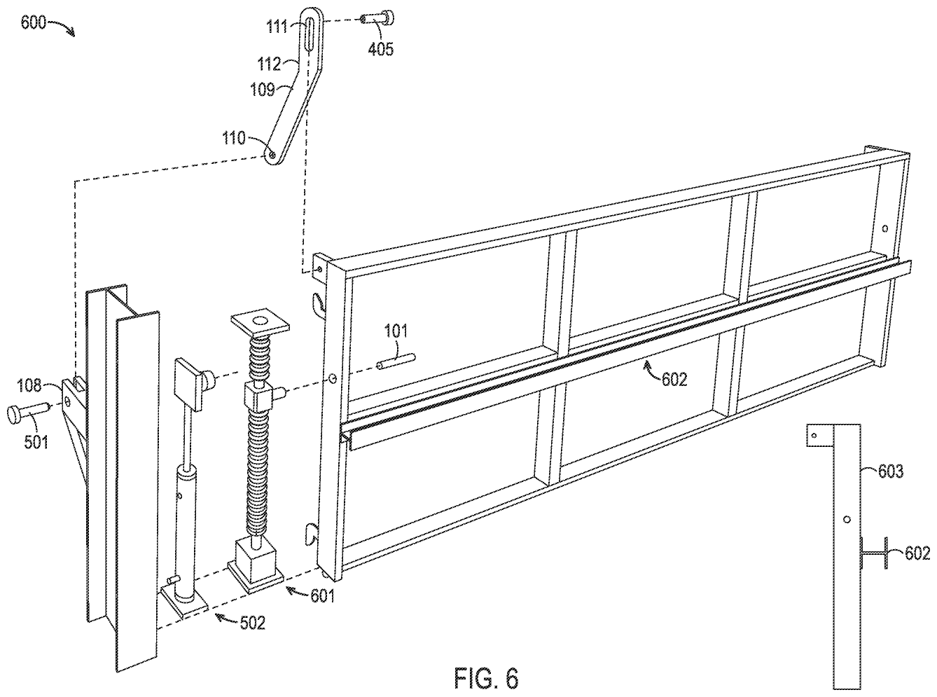

More oversized doors will require a support member. The preferred support member is a truss. FIGS. 2 and 6 show examples of trusses, e.g., 201 and 602. However, non-truss stabilizers can be used; non-limiting examples include a W-stabilizer, 604.

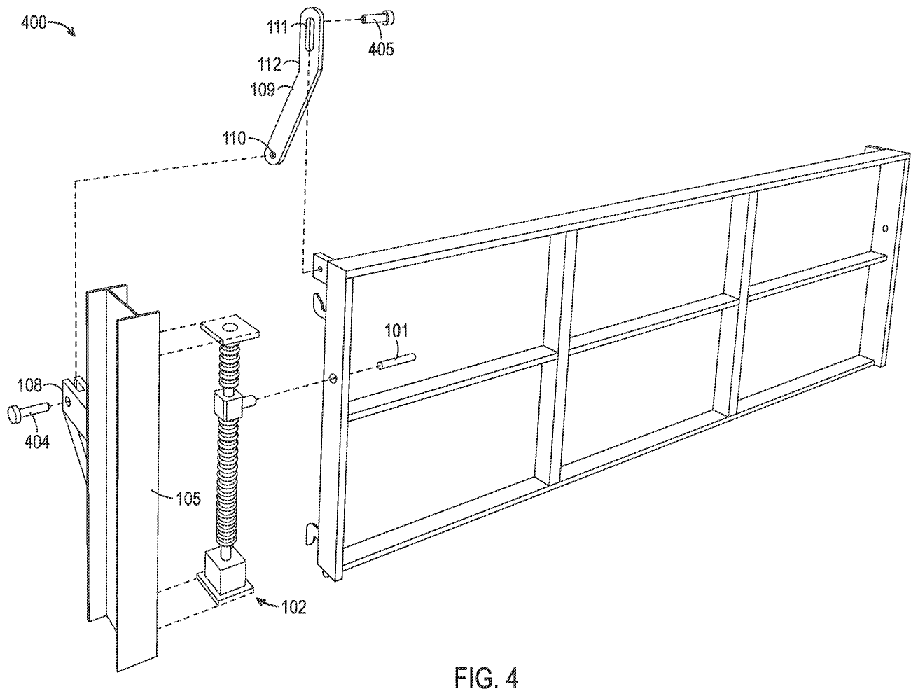

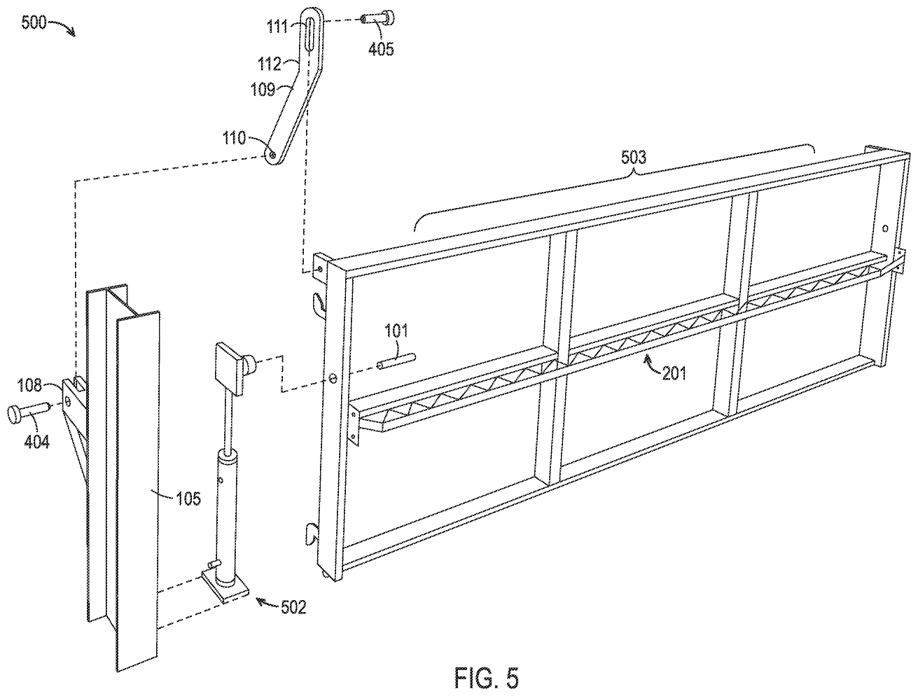

The preferred embodiment is a panel door with the swing/link arm, 109, coupled to the base coupling point, 108, connected directly to column 105. Further, a linear actuator will be included to raise and lower the door. FIGS. 2 through 6 are examples of different embodiments of the invention that are readily understandable by one skilled in the art.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or a related application. Such amended or new claims, whether they are directed to the same invention or a different invention and whether they are different, broader, narrower, or equal in scope to the original claims, are to be considered within the subject matter of the inventions described herein.

1. A panel door with a swing/link arm system comprising: the panel door, a swing/link arm, a base coupling point, a column, and a means to raise and lower the panel door; where the swing/link arm further comprises, a bottom link arm slot, a top arm link slot, and a dog leg and the top arm link slot is elongated; and where the column is coupled to the panel door, and the base coupling point is coupled to the column; and the swing/link arm is coupled to the base coupling point.

2. The panel door with a swing/link arm system of claim 1, where the base coupling point further includes an upper connector and lower connector.

3. The panel door with a swing/link arm system of claim 1, further comprising a stabilizer.

4. The panel door with a swing/link arm system of claim 2, further comprising a stabilizer.

5. The panel door with a swing/link arm system of claim 1, where the means to raise and lower the door comprises a linear actuator or a hydraulic cylinder.

6. The panel door with a swing/link arm system of claim 3, where the means to raise and lower the door comprises a linear actuator or a hydraulic cylinder.

7. The panel door with a swing/link arm system of claim 4, where the means to raise and lower the door comprises a linear actuator or a hydraulic cylinder.

8. The panel door with a swing/link arm system of claim 6, where the stabilizer is a truss or a W-stabilizer; where the W-Stabilizer is in the shape of the letter “H.”

9. The panel door with a swing/link arm system of claim 7, where the stabilizer is a truss or an H-Beam.

10. A panel door with a geometry that allows for easy raising and lowing of a panel door comprising: a panel door, a swing/link arm, a base coupling point; and where the swing/link arm further comprises, a bottom link arm slot, a top arm link slot, and a dog leg and the top arm link slot is elongated; and
where the base coupling point comprises an upper connector and a lower connector;
a column, and a means to raise and lower the panel door;
where the column is coupled to the panel door, the base coupling point is coupled to the column, and the swing/link arm is coupled to the base coupling point; where the means to raise and lower the door comprises a linear actuator or a hydraulic cylinder.

11. A panel door with a geometry that allows for easy raising and lowing of a panel door comprising: a panel door, a swing/link arm, a base coupling point; where the swing/link arm further comprises, a bottom link arm slot, a top arm link slot, and a dog leg and top arm link slot is elongated; and
where the base coupling point comprises an upper connector and a lower connector;
a column, a stabilizer, and a means to raise and lower the panel door;
where the column is coupled to the panel door, the base coupling point is coupled to the column, and the swing/link arm is coupled to the base coupling point; where the stabilizer is a truss or an H-Beam; where the means to raise and lower the door comprises a linear actuator or a hydraulic cylinder.
